(19) United States
(12) Patent Application Publication
(10) Pub. No.: US 2025/0183984 A1
(43) Pub. Date: Jun. 5, 2025

(54) POWER CONTROL PARAMETER RESET ASSOCIATED WITH BEAM FAILURE RECOVERY

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/842,348

(22) PCT Filed: Apr. 22, 2022
(86) PCT No.: PCT/CN2022/088448

§ 371 Date: Aug. 28, 2024

(51) Int. Cl. H04B 7/06; H04L 5/00; H04W 52/14; H04W 52/24

(52) U.S. Cl. CPC H04B 7/06964; H04L 5/0048; H04W 52/146; H04W 52/24

(57) ABSTRACT

Aspects relate to techniques for beam failure recovery (BFR). The technique includes transmitting a beam failure recovery (BFR) request signal with a first transmit-receive beam pair to a network entity using the transceiver; receiving a beam failure recovery (BFR) request response from the network entity using the transceiver; and transmitting an uplink (UL) signal to the network entity using the transceiver, wherein the transmission of the UL signal is in accordance with the first transmit-receive beam pair and a power control parameter assigned to a beam failure recover (BFR) procedure.

### TECHNICAL FIELD

The technology discussed below relates generally to wireless communication networks, and more particularly, to power control parameter reset associated with beam failure recovery.

### INTRODUCTION

Wireless communication systems are widely deployed to provide various telecommunication services such as telephony, video, data, messaging, and broadcasts. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements.

In such wireless communication systems, a user equipment (UE) may communicate with a network entity (e.g., a base station) using directional beams, as they generally provide improved signal transmissions between these two devices. In some cases, the selected directional beam used for communicating between the UE and network entity may fail or be compromised for many different reasons, such as adverse channel conditions, equipment failure or degradation, etc. To address the failure in the currently-selected directional beam, the UE and network entity may undergo a beam failure recovery (BFR) procedure.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a user equipment (UE) configured for wireless communication is provided. The UE includes a transceiver, a memory, and a processor coupled to the transceiver and the memory. The processor being configured to: transmit a beam failure recovery (BFR) request signal with a first transmit-receive beam pair to a network entity using the transceiver; receive a beam failure recovery (BFR) request response from the network entity using the transceiver; and transmit an uplink (UL) signal to the network entity using the transceiver, wherein the transmission of the UL signal is in accordance with the first transmit-receive beam pair and a power control parameter assigned to a beam failure recovery (BFR) procedure.

Another example provides a method for wireless communication at a user equipment (UE). The method includes transmitting a beam failure recovery (BFR) request signal with a first transmit-receive beam pair to a network entity; receiving a beam failure recovery (BFR) request response from the network entity; and transmitting an uplink (UL) signal to the network entity, wherein the transmission of the UL signal is in accordance with the first transmit-receive beam pair and a power control parameter assigned to a beam failure recovery (BFR) procedure.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a diagram illustrating an example of a wireless communication system according to some aspects.

FIG. 2 is a diagram illustrating an example of a radio access network (RAN) according to some aspects.

FIG. 3 is a diagram illustrating an example of a frame structure for use in a wireless communication network according to some aspects.

FIG. 4 is a schematic illustration of an example control channel element (CCE) structure in a DL control portion of a slot according to some aspects.

FIG. 5 is a schematic illustration of a number of example CORESETs of a DL control portion of a slot according to some aspects.

FIG. 6 is a diagram illustrating an example of a wireless communication system supporting beamforming and/or multiple-input multiple-output (MIMO) according to some aspects.

FIG. 7 is a diagram illustrating an example of communication between a base station and a UE using beamforming according to some aspects.

FIG. 8 is a diagram illustrating a multi-panel UE according to some aspects.

FIG. 9 is a diagram illustrating an example of communication between a base station and a UE using previously failed beam and a newly selected beam according to some aspects.

FIG. 10 is a diagram illustrating an example signaling related to a beam failure recovery (BFR) procedure involving power control parameter reset according to some aspects.

FIG. 11 is a block diagram illustrating an example of a hardware implementation of a user equipment (UE) employing a processing system according to some aspects.

FIG. 12 is a flow chart illustrating an exemplary method of resetting power control parameters pursuant to a beam failure recovery procedure according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, radio frequency (RF) chains (RF-chains), power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

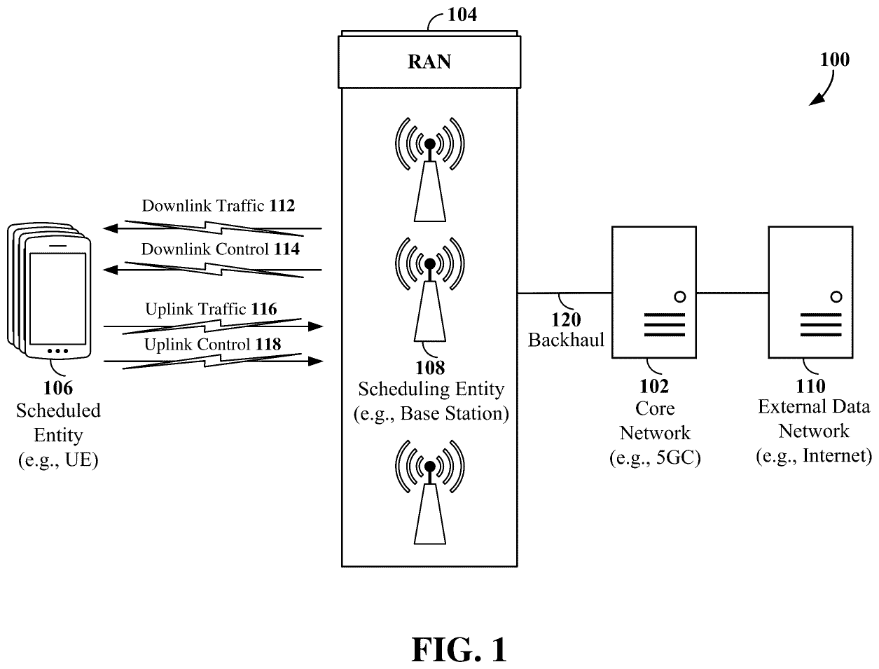

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, TX chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmissions. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control 114 information, including but not limited to scheduling information (e.g., a grant), synchronization or timing information, or other control information from another entity in the wireless communication network such as the scheduling entity 108. The scheduled entity (e.g., a UE 106) may transmit uplink control 118 information including one or more uplink control channels to the scheduling entity 108. Uplink control 118 information may include a variety of packet types and categories, including pilots, reference signals, and information configured to enable or assist in decoding uplink data transmissions.

In addition, the uplink and/or downlink control information and/or traffic information may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

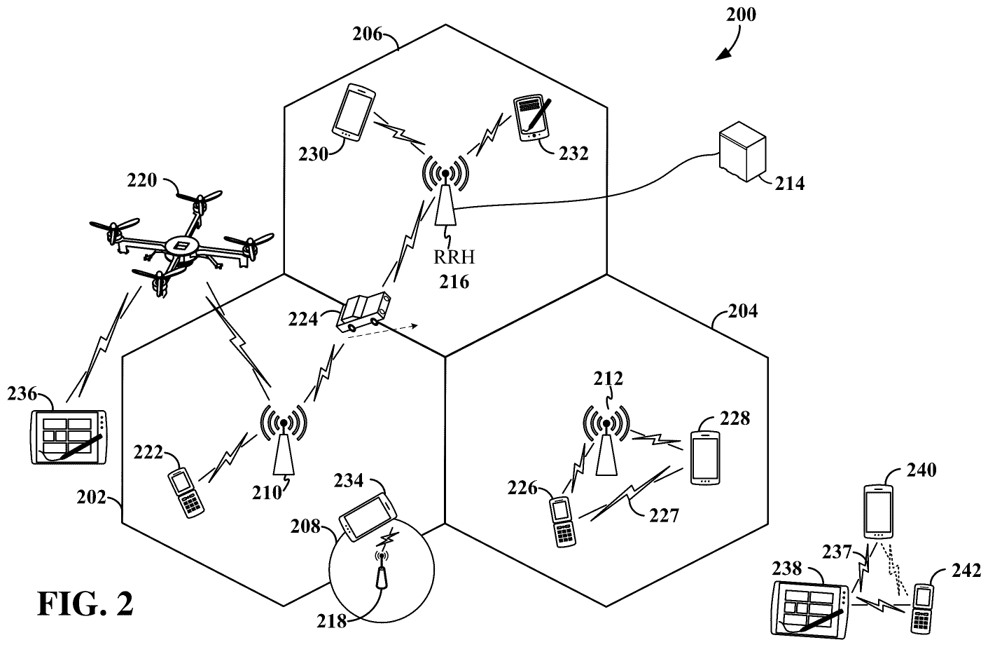

Referring now to FIG. 2, as an illustrative example without limitation, a schematic illustration of an example of a radio access network (RAN) 200 according to some aspects of the disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214, is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHZ), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

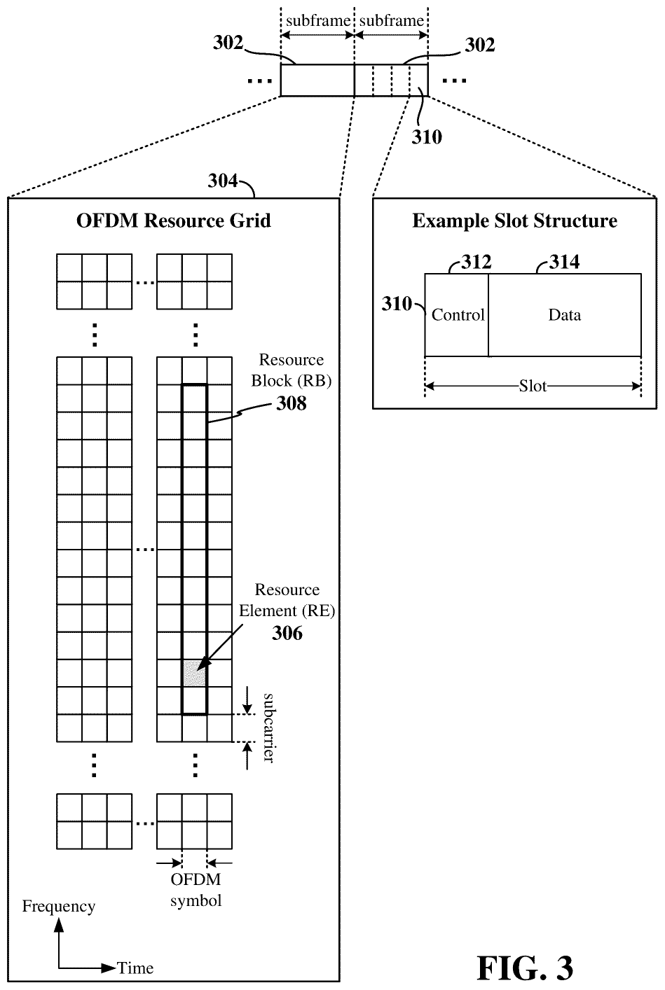

Various aspects of the present disclosure will be described with reference to an orthogonal frequency division multiplexing (OFDM) waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid. However, as those skilled in the art will readily appreciate, the physical (PHY) transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within an RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType1 (SIB1) that may include various additional system information. The MIB and SIB1 together provide the minimum system information (SI) for a random access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 3 are not necessarily all of the channels or carriers that may be utilized between devices, and those of ordinary skill in the art will recognize that other channels or carriers may be utilized in addition to those illustrated, such as other traffic, control, and feedback channels.

In some examples, the PDCCH may be constructed from a variable number of control channel elements (CCEs), depending on the PDCCH format (or aggregation level). Each CCE includes a number of resource elements (REs) that may be grouped into resource element groups (REGs). Each REG generally may contain, for example, twelve consecutive REs (or nine REs and three DMRS REs) within the same OFDM symbol and the same RB. Each PDCCH format (or aggregation level) supports a different DCI length. In some examples, PDCCH aggregation levels of 1, 2, 4, 8, and 16 may be supported, corresponding to 1, 2, 4, 8, or 16 contiguous CCEs, respectively.

Since the UE is unaware of the particular aggregation level of the PDCCH or whether multiple PDCCHs may exist for the UE in the slot, the UE may perform blind decoding of various PDCCH candidates within the first N control OFDM symbols (as indicated by the slot format of the slot) based on an expected RNTI (e.g., UE-specific RNTI or group RNTI). Each PDCCH candidate includes a collection of one or more consecutive CCEs based on an assumed DCI length (e.g., PDCCH aggregation level).

To limit the number of blind decodes, search spaces defining UE-specific search spaces (USSs) and common search spaces (CSSs) may be defined. The search space sets (e.g., USSs and CSSs) configured for a UE limit the number of blind decodes that the UE performs for each PDCCH format combination. The starting point (offset or index) of a UE-specific search space may be different for each UE and each UE may have multiple UE-specific search spaces (e.g., one for each aggregation level). The common search space sets consist of CCEs used for sending control information that is common to a group of UEs or to all UEs. Thus, the common search space sets are monitored by multiple UEs in a cell. The starting point (offset or index) of a search space set for group common control information may be the same for all UEs in the group and there may be multiple search space sets defined for group common control information (e.g., one for each configured aggregation level for the group of UEs). The UE may perform blind decoding over all aggregation levels and corresponding USSs or CSSs to determine whether at least one valid DCI exists for the UE.

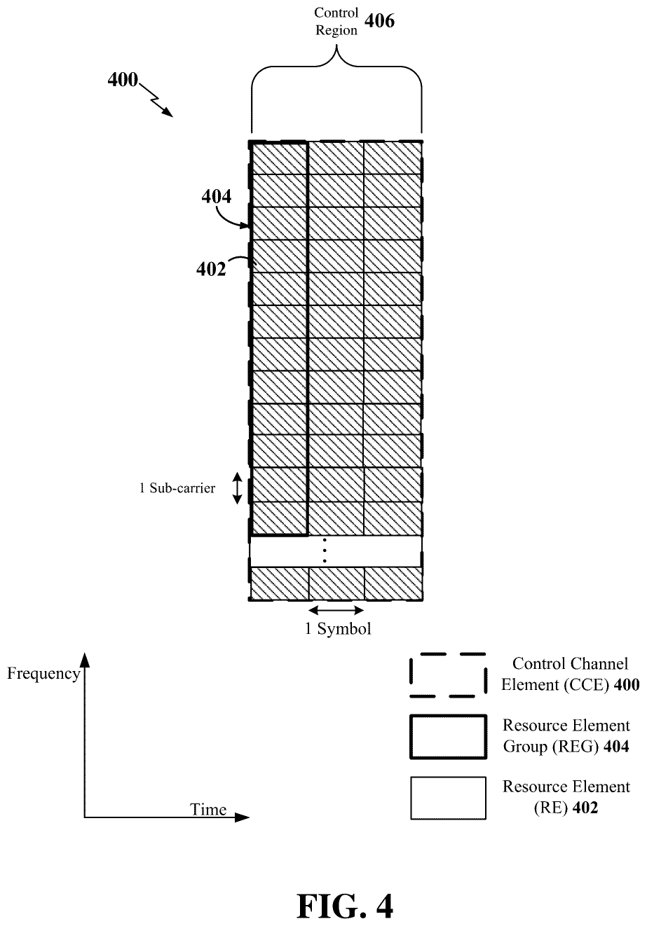

FIG. 4 is a schematic illustration of an example control channel element (CCE) 400 structure in a DL control portion 406 of a slot according to some aspects. The slot may correspond, for example, to the slot illustrated in FIG. 3. The CCE 400 structure of FIG. 4 represents a portion of the DL control portion 406, including a number of REs 402 that may be grouped into REGs 404. Each REG 404 generally may contain, for example, twelve consecutive REs 402 (or nine REs 402 and three DMRS REs) within the same OFDM symbol and the same RB. In this example, the CCE structure 400 includes at least six REGs 404 distributed across three OFDM symbols. However, as those skilled in the art will readily appreciate, the CCE 400 structure for any particular application may vary from the example described herein, depending on any number of factors. For example, the CCE 400 structure may contain any suitable number of REGs.

In some examples, the PDCCH may be constructed from a variable number of CCEs, depending on the PDCCH format (or aggregation level). Each PDCCH format (or aggregation level) supports a different DCI length. In some examples, PDCCH aggregation levels of 1, 2, 4, 8, and 16 may be supported, corresponding to 1, 2, 4, 8, or 16 contiguous CCEs, respectively.

Since the UE is unaware of the particular aggregation level of the PDCCH or whether multiple PDCCHs may exist for the UE in the slot, the UE may perform blind decoding of various PDCCH candidates within the first N control OFDM symbols (as indicated by the slot format of the slot) based on an expected RNTI (e.g., UE-specific RNTI or group RNTI). Each PDCCH candidate includes a collection of one or more consecutive CCEs based on an assumed DCI length (e.g., PDCCH aggregation level).

To limit the number of blind decodes, search spaces defining UE-specific search spaces (USSs) and common search spaces (CSSs) may be defined. The search space sets (e.g., USSs and CSSs) configured for a UE limit the number of blind decodes that the UE performs for each PDCCH format combination. The starting point (offset or index) of a UE-specific search space may be different for each UE and each UE may have multiple UE-specific search spaces (e.g., one for each aggregation level). The common search space sets consist of CCEs used for sending control information that is common to a group of UEs or to all UEs. Thus, the common search space sets are monitored by multiple UEs in a cell. The starting point (offset or index) of a search space set for group common control information may be the same for all UEs in the group and there may be multiple search space sets defined for group common control information (e.g., one for each configured aggregation level for the group of UEs). The UE may perform blind decoding over all aggregation levels and corresponding USSs or CSSs to determine whether at least one valid DCI exists for the UE.

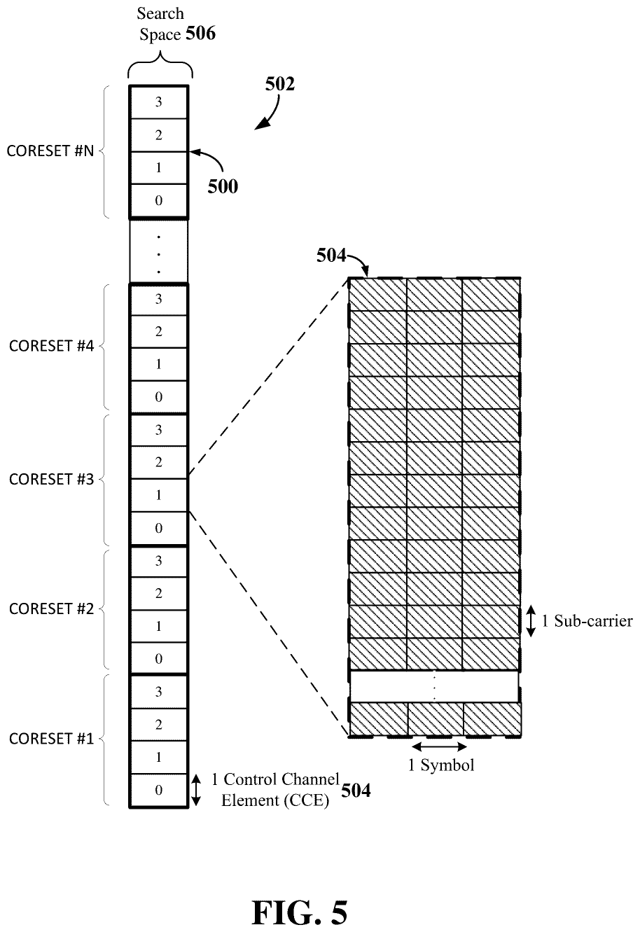

FIG. 5 is a schematic illustration of a number of example CORESETs 500 of a DL control portion 502 of a slot according to some aspects. The DL control portion 502 may correspond, for example, to the DL control portion illustrated in FIG. 3. A CORESET 500 may be configured for group common control information or UE-specific control information and may be used for transmission of a PDCCH including the group common control information or UE-specific control information to a set of one or more UEs. The UE may monitor one or more CORESETs 500 that the UE is configured to monitor for the UE-specific or group common control information.

Each CORESET 500 represents a portion of the DL control portion 502 including a number of sub-carriers in the frequency domain and one or more symbols in the time domain. In the example of FIG. 5, each CORESET 500 includes at least one CCE 504 having dimensions in both frequency and time, sized to span across at least three OFDM symbols. A CORESET having a size that spans across two or more OFDM symbols may be beneficial for use over a relatively small system bandwidth (e.g., 5 MHz). However, a one-symbol CORESET may also be possible.

A plurality of CORESETs 500 indexed as CORESET #1-CORESET #N are shown as occurring during three OFDM symbols in the time domain and occupying a first region of frequency resources in the frequency domain of the DL control portion 502. In the example shown in FIG. 5, each CORESET 500 includes four CCEs 504. It should be noted that this is just one example. In another example, each CORESET 500 may include any suitable number of CCEs 504. The number of CCEs 504 and configuration of CCEs 504 for each CORESET 500 may be dependent, for example, on the aggregation level applied to the PDCCH.

As described above, a search space for a UE is indicated by a set of contiguous CCEs that the UE should monitor for downlink assignments and uplink grants relating to a particular component carrier for the UE. In the example shown in FIG. 5, the plurality of CORESETs 500 may form a search space 506, which may be a USS or a CSS. Within a USS, the aggregation level of a PDCCH may be, for example, 1, 2, 4, or 8 consecutive CCEs and within a CSS, the aggregation level of the PDCCH may be, for example 4 or 8 consecutive CCEs. In addition, the number of PDCCH candidates within each search space may vary depending on the aggregation level utilized. For example, for a USS with an aggregation level of 1 or 2, the number of PDCCH candidates may be 6. In this example, the number of CCEs in the USS search space 506 for an aggregation level of 1 may be 6, and the number of CCEs in the USS search space 506 for an aggregation level of 2 may be 12. However, for a USS with an aggregation level of 4 or 8, the number of PDCCH candidates may be 2. In this example, the number of CCEs in the USS search space 506 for an aggregation level of 4 may be 8, and the number of CCEs in the USS search space 506 for an aggregation level of 8 may be 16. For a CSS search space 506, the number of CCEs in the search space 506 may be 16 regardless of the aggregation level.

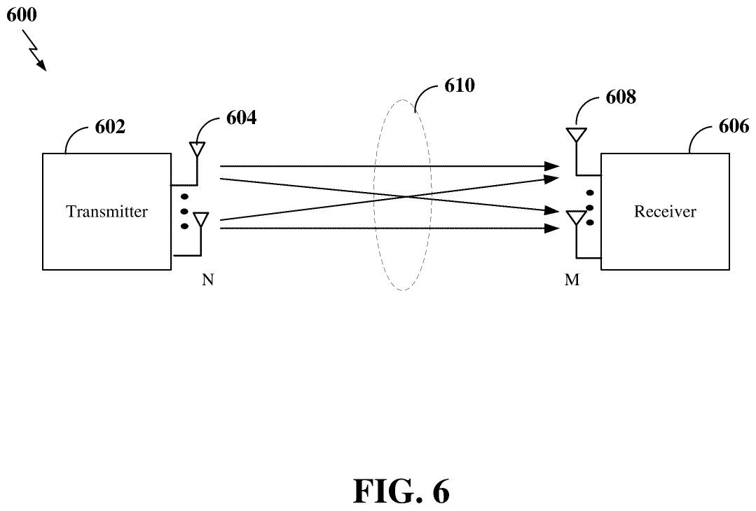

In some aspects of the disclosure, the scheduling entity (e.g., base station) and/or scheduled entity (e.g., UE) may be configured for beamforming and/or multiple-input multiple-output (MIMO) technology. FIG. 6 is a diagram illustrating an example of a wireless communication system 600 supporting beamforming and/or multiple-input multiple-output (MIMO) according to some aspects. In a MIMO system, a transmitter 602 includes multiple transmit antennas 604 (e.g., N transmit antennas) and a receiver 606 includes multiple receive antennas 608 (e.g., M receive antennas). Thus, there are N×M signal paths 610 from the transmit antennas 604 to the receive antennas 608. The multiple transmit antennas 604 and multiple receive antennas 608 may each be configured in a single panel or multi-panel antenna array. Each of the transmitter 602 and the receiver 606 may be implemented, for example, within a scheduling entity (e.g., base station 108), as illustrated in FIGS. 1 and/or 2, a scheduled entity (e.g., UE 106), as illustrated in FIGS. 1 and/or 2, or any other suitable wireless communication device.

The use of such multiple antenna technology enables the wireless communication system 600 to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the MIMO system (e.g., the wireless communication system 600 supporting MIMO) is limited by the number of transmit or receive antennas 604 or 608, whichever is lower. In addition, the channel conditions at the UE, as well as other considerations, such as the available resources at the base station, may also affect the transmission rank. For example, the rank (and therefore, the number of data streams) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-plus-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

In Time Division Duplex (TDD) systems, the UL and DL are reciprocal, in that each uses different time slots of the same frequency bandwidth. Therefore, in TDD systems, the base station may assign the rank for DL MIMO transmissions based on UL SINR measurements (e.g., based on a sounding reference signal (SRS) transmitted from the UE or other pilot signal). Based on the assigned rank, the base station may then transmit a channel state information-reference signal (CSI-RS) with separate CSI-RS sequences for each layer to provide for multi-layer channel estimation. From the CSI-RS, the UE may measure the channel quality across layers and resource blocks and feed back channel quality indicator (CQI) and rank indicator (RI) values to the base station for use in updating the rank and assigning REs for future downlink transmissions.

In one example, as shown in FIG. 6, a rank-2 spatial multiplexing transmission on a 2×2 MIMO antenna configuration will transmit one data stream from each of the transmit antennas 604. Each data stream reaches each of the receive antennas 608 along a different one of the signal paths 610. The receiver 606 may then reconstruct the data streams using the received signals from each of the receive antennas 608.

Beamforming is a signal processing technique that may be used at the transmitter 602 or receiver 606 to shape or steer an antenna beam (e.g., a transmit/receive beam) along a spatial path between the transmitter 602 and the receiver 606. Beamforming may be achieved by combining the signals communicated via antennas 604 or 608 (e.g., antenna elements of an antenna array) such that some of the signals experience constructive interference while others experience destructive interference. To create the desired constructive/destructive interference, the transmitter 602 or receiver 606 may apply amplitude and/or phase offsets to signals transmitted or received from each of the antennas 604 or 608 associated with the transmitter 602 or receiver 606.

A base station (e.g., gNB) may generally be capable of communicating with UEs using transmit beams (e.g., downlink transmit beams) of varying beam widths. For example, a base station may be configured to utilize a wider beam when communicating with a UE that is in motion and a narrower beam when communicating with a UE that is stationary. The UE may further be configured to utilize one or more downlink receive beams to receive signals from the base station.

In some examples, to select one or more serving beams (e.g., one or more downlink transmit beams and one or more downlink receive beams) for communication with a UE, the base station may transmit a reference signal, such as a synchronization signal block (SSB), a tracking reference signal (TRS), or a channel state information reference signal (CSI-RS), on each of a plurality of beams (e.g., on each of a plurality of downlink transmit beams) in a beam-sweeping manner. The UE may measure the reference signal received power (RSRP) on each of the beams (e.g., measure RSRP on each of the plurality of downlink transmit beams) and transmit a beam measurement report to the base station indicating the Layer 1 RSRP (L-1 RSRP) of each of the measured beams. The base station may then select the serving beam(s) for communication with the UE based on the beam measurement report. In other examples, when the channel is reciprocal, the base station may derive the particular beam(s) (e.g., the particular downlink beam(s)) to communicate with the UE based on uplink measurements of one or more uplink reference signals, such as a sounding reference signal (SRS).

Similarly, uplink beams (e.g., uplink transmit beam(s) at the UE and uplink receive beam(s) at the base station) may be selected by measuring the RSRP of received uplink reference signals (e.g., SRSs) or downlink reference signals (e.g., SSBs or CSI-RSs) during an uplink or downlink beam sweep. For example, the base station may determine the uplink beams either by uplink beam management via an SRS beam sweep with measurement at the base station or by downlink beam management via an SSB/CSI-RS beam sweep with measurement at the UE. The selected uplink beam may be indicated by a selected SRS resource (e.g., time-frequency resources utilized for the transmission of an SRS) when implementing uplink beam management or a selected SSB/CSI-RS resource when implementing downlink beam management. For example, the selected SSB/CSI-RS resource can have a spatial relation to the selected uplink transmit beam (e.g., the uplink transmit beam utilized for the PUCCH, SRS, and/or PUSCH). The resulting selected uplink transmit beam and uplink receive beam may form an uplink beam pair link.

In 5G New Radio (NR) systems, particularly for above 6 GHz or millimeter wave (mmWave) systems (e.g., FR2 or above), beamformed signals may be utilized for downlink channels, including the physical downlink control channel (PDCCH) and physical downlink shared channel (PDSCH). In addition, for UEs configured with beamforming antenna panels, beamformed signals may also be utilized for uplink channels, including the physical uplink control channel (PUCCH) and the physical uplink shared channel (PUSCH).

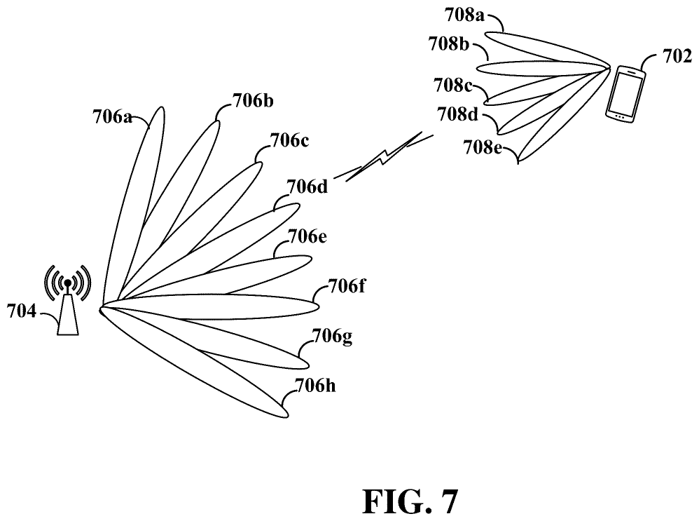

FIG. 7 is a diagram illustrating an example of communication between a base station 704 and a UE 702 using beamforming according to some aspects. The base station 704 may be any of the base stations (e.g., gNBs) or scheduling entities illustrated in FIG. 1, 2, or 4, and the UE 702 may be any of the UEs or scheduled entities illustrated in FIG. 1, 2, or 4.

The base station 704 may generally be capable of communicating with the UE 702 using one or more transmit beams, and the UE 702 may further be capable of communicating with the base station 704 using one or more receive beams. As used herein, the term transmit beam refers to a beam on the base station 704 that may be utilized for downlink or uplink communication with the UE 702. In addition, the term receive beam refers to a beam on the UE 702 that may be utilized for downlink or uplink communication with the base station 704.

In the example shown in FIG. 7, the base station 704 is configured to generate a plurality of transmit beams 706a, 706b, 706c, 706d, 706e, 706f, 706g, and 706h (706a-706h), each associated with a different spatial direction. In addition, the UE 702 is configured to generate a plurality of receive beams 708a, 708b, 708c, 708d, and 708e (708a-708e), each associated with a different spatial direction. It should be noted that while some beams are illustrated as adjacent to one another, such an arrangement may be different in different aspects. For example, transmit beams 706a-706h transmitted during a same symbol may not be adjacent to one another. In some examples, the base station 704 and UE 702 may each transmit more or less beams distributed in all directions (e.g., 360 degrees) and in three-dimensions. In addition, the transmit beams 706a-706h may include beams of varying beam width. For example, the base station 704 may transmit certain signals (e.g., synchronization signal blocks (SSBs)) on wider beams and other signals (e.g., CSI-RSs) on narrower beams.

The base station 704 and UE 702 may select one or more transmit beams 706a-706h on the base station 704 and one or more receive beams 708a-708e on the UE 702 for communication of uplink and downlink signals therebetween using a beam management procedure. In one example, during an initial cell acquisition, the UE 702 may perform a P1 beam management procedure to scan the plurality of transmit beams 706a-706h using the plurality of receive beams 708a-708e to select a beam pair link (e.g., one of the transmit beams 706a-706h and one of the receive beams 708a-708e) for a physical random access channel (PRACH) procedure for initial access to the cell. For example, periodic SSB beam sweeping may be implemented on the base station 704 at certain intervals (e.g., based on the SSB periodicity). Thus, the base station 704 may be configured to sweep or transmit an SSB on each of a plurality of wider transmit beams 706a-706h during the beam sweeping interval. The UE 702 may measure the reference signal received power (RSRP) of each of the SSB transmitted on each of the transmit beams 706a-706h on each of the receive beams 708a-708e of the UE 702. The UE 702 may select the transmit and receive beams based on the measured RSRP. In an example, the selected receive beam may be the receive beam on which the highest RSRP is measured and the selected transmit beam may have the highest RSRP as measured on the selected receive beam.

After completing the PRACH procedure, the base station 704 and UE 702 may perform a P2 beam management procedure for beam refinement at the base station 704. For example, the base station 704 may be configured to sweep or transmit a CSI-RS on each of a plurality of narrower transmit beams 706a-706h. Each of the narrower CSI-RS beams may be a sub-beam (not shown) of the selected SSB transmit beam (e.g., within the spatial direction of the SSB transmit beam). Transmission of the CSI-RS transmit beams may occur periodically (e.g., as configured via radio resource control (RRC) signaling by the gNB), semi-persistently (e.g., as configured via RRC signaling and activated/deactivated via medium access control-control element (MAC-CE) signaling by the gNB), or aperiodically (e.g., as triggered by the gNB via downlink control information (DCI)). The UE 702 may be configured to scan the plurality of CSI-RS transmit beams 706a-706h on the plurality of receive beams 708a-708e. The UE 702 may then perform beam measurements (e.g., measurements of RSRP, SINR, etc.) of the received CSI-RSs on each of the receive beams 708a-708e to determine the respective beam quality of each of the CSI-RS transmit beams 706a-706h as measured on each of the receive beams 708a-708e.

The UE 702 can then generate and transmit a Layer 1 (L1) measurement report, including the respective beam index (e.g., CSI-RS resource indicator (CRI)) and beam measurement (e.g., RSRP or SINR) of one or more of the CSI-RS transmit beams 706a-706h on one or more of the receive beams 708a-708e to the base station 704. The base station 704 may then select one or more CSI-RS transmit beams on which to communicate downlink and/or uplink control and/or data with the UE 702. In some examples, the selected CSI-RS transmit beam(s) have the highest RSRP from the L1 measurement report. Transmission of the L1 measurement report may occur periodically (e.g., as configured via RRC signaling by the gNB), semi-persistently (e.g., as configured via RRC signaling and activated/deactivated via MAC-CE signaling by the gNB), or aperiodically (e.g., as triggered by the gNB via DCI).

The UE 702 may further select a corresponding receive beam on the UE 702 for each selected serving CSI-RS transmit beam to form a respective beam pair link (BPL) for each selected serving CSI-RS transmit beam. For example, the UE 702 may utilize the beam measurements obtained during the P2 procedure or perform a P3 beam management procedure to obtain new beam measurements for the selected CSI-RS transmit beams to select the corresponding receive beam for each selected transmit beam. In some examples, the selected receive beam to pair with a particular CSI-RS transmit beam may be the receive beam on which the highest RSRP for the particular CSI-RS transmit beam is measured.

In some examples, in addition to performing CSI-RS beam measurements, the base station 704 may configure the UE 702 to perform SSB beam measurements and provide an L1 measurement report including beam measurements of SSB transmit beams 706a-706h. For example, the base station 704 may configure the UE 702 to perform SSB beam measurements and/or CSI-RS beam measurements for beam failure detection (BFD), beam failure recovery (BFR), cell reselection, beam tracking (e.g., for a mobile UE 702 and/or base station 704), or other beam optimization purposes.

In addition, when the channel is reciprocal, the transmit and receive beams may be selected using an uplink beam management scheme. In an example, the UE 702 may be configured to sweep or transmit on each of a plurality of receive beams 708a-708e. For example, the UE 702 may transmit an SRS on each beam in the different beam directions. In addition, the base station 704 may be configured to receive the uplink beam reference signals on a plurality of transmit beams 706a-706h. The base station 704 may then perform beam measurements (e.g., RSRP, SINR, etc.) of the beam reference signals on each of the transmit beams 706a-706h to determine the respective beam quality of each of the receive beams 708a-708e as measured on each of the transmit beams 706a-706h.

The base station 704 may then select one or more transmit beams on which to communicate downlink and/or uplink control and/or data with the UE 702. In some examples, the selected transmit beam(s) may have the highest RSRP. The UE 702 may then select a corresponding receive beam for each selected serving transmit beam to form a respective beam pair link (BPL) for each selected serving transmit beam, using, for example, a P3 beam management procedure, as described above.

In one example, a single CSI-RS transmit beam (e.g., transmit beam 706d) on the base station 704 and a single receive beam (e.g., receive beam 708c) on the UE 702 may form a single BPL used for communication between the base station 704 and the UE 702. In another example, multiple CSI-RS transmit beams (e.g., transmit beams 706c, 706d, and 706e) on the base station 704 and a single receive beam (e.g., receive beam 708c) on the UE 702 may form respective BPLs used for communication between the base station 704 and the UE 702. In another example, multiple CSI-RS transmit beams (e.g., transmit beams 706c, 706d, and 706e) on the base station 704 and multiple receive beams (e.g., receive beams 708c and 708d) on the UE 702 may form multiple BPLs used for communication between the base station 704 and the UE 702. In this example, a first BPL may include transmit beam 706c and receive beam 708c, a second BPL may include transmit beam 706d and receive beam 708c, and a third BPL may include transmit beam 706e and receive beam 708d. For example, the UE 702 may be configured with multiple antenna panels for communication with the base station 704 on multiple UE beams.

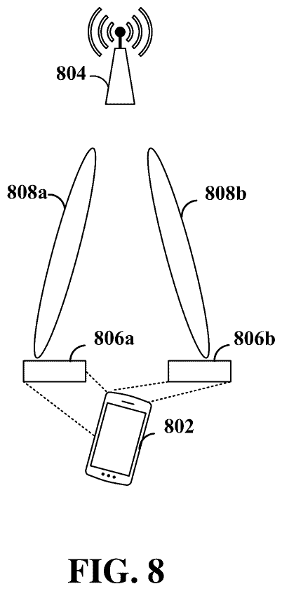

FIG. 8 is a diagram illustrating a multi-panel UE (MP-UE) 802 according to some aspects. The MP-UE 802 can include multiple antenna panels (e.g., antenna panels 806a and 806b). For example, the antenna panels 806a and 806b may be located at various positions on the UE 802 to enable the plurality of antenna panels 806a and 806b to cover a sphere surrounding the UE 802. The plurality of antenna panels 806a and 806b (or any one antenna panel among them) may support a plurality of beams (e.g., beams 808a and 808b). For example, each of the antenna panels 806a and 806b includes a plurality of antenna elements that may be mapped to antenna ports for generation of the beams 808a and 808b. Here, the term antenna port refers to a logical port (e.g., a beam) over which a signal (e.g., a data stream or layer) may be transmitted.

The multiple panels may provide flexibility in selection of antennas for wireless communication with a network entity 804 (e.g., a base station, such as a gNB). For example, the MP-UE 802 can activate or deactivate one or more panels in order to improve performance and/or reduce battery consumption. By controlling the activation and deactivation of the panels 806a and 806b, the MP-UE 802 can control various operational aspects, for example, maximum permissible exposure (MPE), power consumption, UL interference management, etc. In some aspects, the panel selection for UL transmission can be initiated by the UE 802 and/or the network entity 804.

In some examples, the MP-UE 802 can use different sets of panels 806a and 806b for downlink and uplink communications. In one example, the MP-UE 802 can use panel 806a for downlink communication and use panel 806b for uplink communication. In other examples, the MP-UE 802 can use both panels 806a and 806b for communication in the same direction. For example, the MP-UE 802 can transmit or receive multiple beams using the panels 806a and 806b.

Generally speaking, two signals transmitted from the same antenna port should experience the same radio channel, whereas transmitting signals from two different antenna ports should experience different radio conditions. In some cases, transmitted signals from two different antenna ports experience radio channels having common properties. In such cases, the antenna ports are said to be in quasi-colocation (QCL). Two antenna ports may be considered quasi co-located if properties of the channel over which a symbol on one antenna port is conveyed can be inferred from the channel over which a symbol on the other antenna port is conveyed. In 5G NR, UE are equipped with channel estimation, frequency offset error estimation and synchronization procedures for processing QCL. For example, if the UE knows that the radio channels corresponding to two different antenna ports are QCL in terms of Doppler shift, then the UE can determine the Doppler shift for one antenna port and then apply the result on both antenna ports for channel estimation. This avoids the UE having to calculate Doppler shift for both antenna ports separately.

Four types of QCL are defined in 5G NR: QCL-TypeA; QCL-TypeB; QCL-TypeC; and QCL-TypeD. For example, QCL-TypeA may indicate a downlink reference signal (e.g., SSB or CSI-RS) or uplink reference signal (e.g., SRS) from which the large-scale channel properties (LSCPs), such as Doppler shift, Doppler spread, average delay, and/or delay spread, of a downlink channel or signal or uplink channel or signal may be inferred. QCL-TypeB and QCL-TypeC may also indicate reference signals (e.g., SSB, CSI-RS, or SRS) from which specific LSPCPs (e.g., Doppler shift and/or Doppler spread for QCL-TypeB and average delay and/or delay spread for QCL-TypeC) may be inferred. QCL-TypeD may indicate a spatial RX parameter (e.g., spatial property of the beam on which a downlink/uplink channel or signal is transmitted). The spatial property of the beam may be inferred from the beam utilized for transmission of a reference signal (e.g., SSB, CSI-RS, or SRS) and may indicate, for example, at least one of a beam direction or a beam width.

QCL information may be conveyed via transmission configuration indicator (TCI) states. A TCI state includes or maps to QCL relationship configurations between one or more reference signals (e.g., SSB, CSI-RS, and SRS) and downlink (DL) or uplink (UL) transmissions. For example, a TCI state may include a DL TCI for only downlink transmissions, a joint DL/UL TCI for both downlink and uplink transmissions, an uplink TCI or spatial relation information for only UL transmissions. For example, the TCI state can include one or more reference signal identifiers (ID)s, each identifying an SSB resource, a CSI-RS resource, or an SRS resource. Each resource (SSB, CSI-RS, or SRS resource) indicates the particular beam, frequency resource, and OFDM symbol on which the corresponding reference signal is communicated. Thus, in examples in which the TCI state indicates QCL-TypeD for a downlink or uplink transmission, the reference signal ID may be utilized to identify the beam to be used for the downlink or uplink transmission based on the QCL relationship with an associated reference signal (e.g., SSB, CSI-RS, or SRS) indicated in the TCI state. The TCI may be a unified TCI.

Various types of unified TCI may be used for communications. For instance, a first type of unified TCI (e.g., Type 1 TCI) may be used to indicate a common beam for at least one downlink channel or reference signal and for at least one uplink channel or reference signal (e.g., a joint downlink uplink common TCI state). A second type of unified TCI (e.g., Type 2 TCI) may be used to indicate a common beam for more than one downlink channel or reference signal (e.g., a separate downlink common TCI state). A third type of unified TCI (e.g., Type 3 TCI) may be used to indicate a common beam for more than one uplink channel or reference signal (e.g., a separate uplink common TCI state). A fourth type of unified TCI (e.g., Type 4 TCI) may be used to indicate a beam for a single downlink channel or reference signal (e.g., a separate downlink single channel or reference signal TCI). A fifth type of unified TCI (e.g., Type 5 TCI) may be used to indicate a beam for a single uplink channel or reference signal (e.g., a separate uplink single channel or reference signal TCI). A sixth type of unified TCI (e.g., Type 6 TCI) may include uplink spatial relation information (SRI) to indicate a beam for a single uplink channel or reference signal.

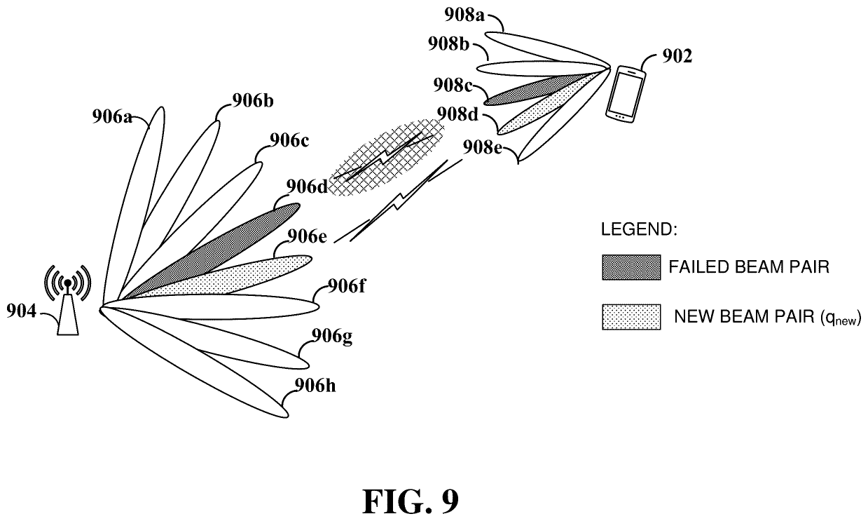

FIG. 9 is a diagram illustrating an example of communication between a network entity (e.g., base station) 904 and a UE 902 using previously failed beam and a newly selected beam according to some aspects. Similar to the base station 704 previously discussed, the network entity 904 may communicate with the UE 902 using a selected one of a set of directional transmit beams 906a to 906h. In this example, the current transmit beam selected is 906d, as depicted with the darker shaded one among the set of transmit beams 906a to 906h. Similarly, the UE 902 may communicate with the network entity using a selected one of a set of directional receive beams 908a to 908e. In this example, the current receive beam selected is 908c, as depicted with the darker shaded one among the set of receive beams 908a to 908e.

In many cases, the communication between the network entity 904 and the UE 902 using the transmit-receive beam pair 906d-908c may be adversely impacted due to equipment and/or communication channel conditions. For example, one or more of the network entity 904 or UE 902 may have transmitter and/or receiver component failure or degradation, which reduces the quality of the communication between the network entity 904 and the UE 902 using the transmit-receive beam pair 906d-908c. Alternatively, or in addition to, the communication channel between the network entity 904 and the UE 902 using the transmit-receive beam pair 906d-908c may experience degradation due to various reasons, such as blockage or partial blockage, fading, multipath propagation, etc.

This degradation in the communication between the network entity 904 and the UE 902 using the current transmit-receive beam pair 906d-908c is sometimes referred to in the relevant art as a “beam failure.” In response to the beam failure, the network entity 904 and UE 902 undergo a beam failure recovery (BFR) procedure for selecting a new transmit-receive beam pair for communicating with each other; the new transmit-receive beam pair not experiencing the communication degradation as discussed with the current transmit-receive beam pair 906d-908c. For instance, in this example, due to a successful BFR procedure, the network entity 904 and the UE 902 have selected and are now communicating with new transmit-receive beam pair 906e-908d, as depicted with the lighter shaded pair among the sets of transmit beams 906a-906h and receive beams 908a to 908e.

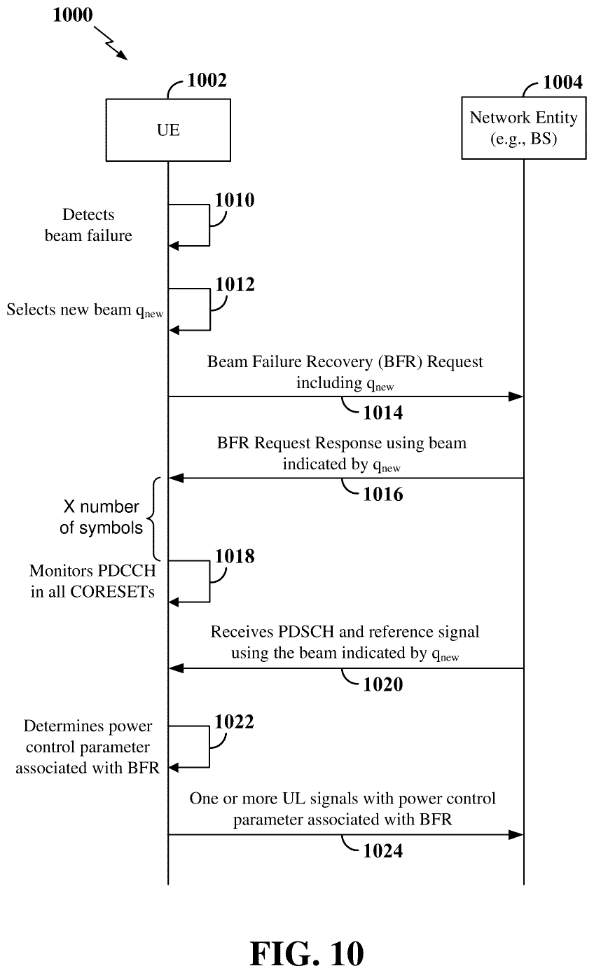

FIG. 10 is a diagram illustrating an example signaling related to a beam failure recovery (BFR) procedure 1000 involving power control parameter reset according to some aspects. The left-side of the diagram represents the operations of a UE 1002 in accordance with the BFR procedure 1000. The right-side of the diagram represents the operations of a network entity 1004 in accordance with the BFR procedure 1000.

According to the BFR procedure 1000, the UE 1002 detects a beam failure associated with the current transmit-receive beam pair (block 1010). For example, the UE 1002 may measure one or more DL signal quality parameters in beam failure detection resources to detect a beam failure. As an example, the UE 1002 may detect a beam failure if a DL reference signal received power (RSRP) decreases below a certain threshold. Alternatively, or in addition to, the UE 1002 may detect a beam failure if a signal-to-interference-plus-noise ratio (SINR) of a DL signal decreases below a certain threshold. Alternatively, or in addition to, the UE 1002 may detect a beam failure if a block error rate (BLER) associated with a DL signal is above a certain threshold. The DL signal or reference signal mentioned above may refer to an SSB, a TRS, and/or a CSI-RS.

In response to detecting a beam failure, the UE 1002 may select a new transmit-receive beam pair for subsequent communications with the network entity 1004 (block 1012). For example, the UE 1002 may have previously performed a beam management procedure (e.g., a P1, P2, and/or P3 beam management procedure) to determine a set of link quality parameters (e.g., RSRP, SINR, BLER, etc.) associated with a set of receive beams in new beam candidate reference signal resources. Based on the set of link quality parameters, the UE 1002 selects a new beam candidate reference signal index q_{new}, for example, having the highest RSRP and/or SINR, or the lowest BLER among the set of receive beams in the new beam candidate resources. The new beam candidate reference signal index q_{new} may be associated with a unified transmission configuration indicator (TCI) state, meaning that the transmit-receive beam pair may be used for transmission and/or reception via a plurality of DL and/or UL channels or signals.

Then, following the selection of the new beam candidate reference signal index q_{new}, the UE 1002 sends a beam failure recovery (BFR) request 1014 to the network entity 1004, which indicates the new beam candidate reference signal index q_{new}. The BFR request 1014 may be sent via a PUSCH transmission, and may have an associated HARQ process number. In response to the BFR request 1014, the network entity 1004 sends a beam failure recovery (BFR) request response 1016 to the UE 1002 using the beam indicated by the new beam candidate reference signal index q_{new}. The BFR beam failure recovery (BFR) request response 1016 may be sent in the PDCCH and may include a DCI scheduling an UL transmission (e.g., PUSCH transmission). The beam failure recovery (BFR) request response 1016 may include information from which the UE 1002 may discern that it is a response to the beam failure recovery (BFR) request 1014. For example, the beam failure recovery (BFR) request response 1016 may include the same HARQ process number as the PUSCH transmission of the BFR request 1014 and a toggled new data assignment (NDI) value indicating that the beam failure recovery (BFR) request 1014 was successfully received.

Then after a defined time interval from the reception of the beam failure recovery (BFR) request response 1016 (e.g., a time interval indicated by X OFDM symbols, such as X=28), the UE 1002 may monitor the PDCCH in all CORESETs to receive scheduled DL data via a PDSCH from the network entity 1004 (block 1018). Then, the UE 1002 receives the data via the PDSCH and a reference signal 1020 (e.g., an aperiodic CSI-RS in a resource from a CSI-RS resource set) using the same antenna port quasi co-location parameters as the ones associated with the new beam candidate reference signal index q_{new}.

Using the reference signal associated with the new beam candidate reference signal index q_{new}, the UE 1002 then determines power control parameter for UL signal transmission assigned to a beam failure recovery (BFR) procedure based on predetermined rules (block 1022). The power control parameter may include a nominal transmit power to achieve a target signal-to-noise ratio (SNR) or target received signal power associated with the UL signal at the network entity 1004.

The power control parameter may also include an estimated signal pathloss between the UE 1002 and the network entity 1004, which may be calculated using the reference signal associated with the new beam candidate information q_{new}. In some aspects, the reference signal associated with the new beam candidate reference signal index q_{new} used for pathloss estimate after receiving the BFR request response 1016 may be a configured pathloss reference signal that uses the same antenna port quasi co-location parameters as the reference signal of the new beam candidate reference signal index q_{new}. In some aspects, the reference signal associated with the new beam candidate reference signal index q_{new} used for pathloss estimate after the BFR request response 1016 may be a periodical reference signal (e.g., CSI-RS) that uses the same antenna port quasi co-location parameters as the reference signal of the new beam candidate reference signal index q_{new}. In some aspects, the reference signal associated with the new beam candidate reference signal index q_{new} used for pathloss estimate after the BFR request response 1016 may be the reference signal of the new beam candidate reference signal index q_{new}.

The power control parameter may further include a closed-loop power adjustment component, which is indexed as l. The UL transmit power may be the lesser of a sum of the nominal power, the estimated pathloss, and the closed-loop adjustment power, or a specified maximum transmit power. If the UL transmission pertains to a PUSCH, PUCCH or SRS transmission, the nominal power is indexed as j for PUSCH, qᵤ for PUCCH, and qₛ for SRS, the reference signal for estimated pathloss is indexed as q_{d}, and the closed-loop power adjustment is indexed as l. The transmit powers for PUSCH, PUCCH, and SRS are defined in sections 7.1.1, 7.2.1, and 7.3.1 of the 3^{rd} Generation Partnership; Technical Specification Group Radio Access Network; NR; Physical layer procedures for control (Release 17) (hereinafter “Rel. 17 NR Specification”).

In accordance with one option (e.g., “option 1”), the power control parameter may entail a selected nominal power index (e.g., j=2) among a set of different (increasing) nominal power indices j∈{0, 1, . . . , J−1}, an estimated pathloss determined based on the reference signal associated with the new beam candidate reference signal index q_{new} (q_{d}=q_{new}), and a selected closed-loop power adjustment index (e.g., l=0) among a set of different (increasing) closed-loop power adjustment indices l∈{0,1} for a PUSCH transmission. In accordance with option 1, the power control parameter may entail a selected nominal power index (e.g., qᵤ=0) among a set of different (increasing) nominal power indices 0≤qᵤ<Qᵤ, an estimated pathloss determined based on the reference signal associated with the new beam candidate reference signal index q_{new} (q_{d}=q_{new}), and a selected closed-loop power adjustment index (e.g., l=0) among a set of different (increasing) closed-loop power adjustment indices l∈{0,1} for a PUCCH transmission. Further, in accordance with option 1, the power control parameter may entail a nominal power based on selected resource set (e.g., qₛ=0), an estimated pathloss determined based on the reference signal associated with the new beam candidate reference signal index q_{new} (q_{d}=q_{new}), and a selected closed-loop power adjustment index (e.g., l=0) among a set of different (increasing) closed-loop power adjustment indices l∈{0,1} for an SRS transmission.

In accordance with another option (e.g., “option 2”), the power control parameter may entail a selected nominal power index (e.g., j=0) for a random access PUSCH transmission, a selected nominal power index (e.g., j=1) for configuring a grant of a PUSCH transmission, and a selected nominal power index (e.g., j=2) for configuring a dynamic granted PUSCH transmission; an estimated pathloss determined based on the reference signal associated with the new beam candidate reference signal index q_{new} (q_{d}=q_{new}); and a selected closed-loop power adjustment index (e.g., l=0) for a PUSCH transmission. In accordance with option 2, the power control parameter may entail a selected nominal power index (e.g., qᵤ=0), an estimated pathloss determined based on the reference signal associated with the new beam candidate reference signal index q_{new} (q_{d}=q_{new}), and a selected closed-loop power adjustment index (e.g., l=0) for a PUCCH transmission. Further, in accordance with option 2, the power control parameter may entail a nominal power selected from resource set qₛ=0 or 1, an estimated pathloss determined based on the reference signal associated with the new beam candidate reference signal index q_{new} (q_{d}=q_{new}), and a closed-loop power adjustment index (e.g., l=0) for an SRS transmission.

Thus, with regard to section 6 entitled “Link recovery procedures” of the Rel. 17 NR Specification or all other subsequent versions that adopt the following specification, the following clause dealing with beam failure recovery (BFR) therein may be revised as follows if option 1 is adopted:

If a UE is provided TCI-State_r17 indicating a unified TCI state, after X symbols from a last symbol of a PDCCH reception with a DCI format scheduling a PUSCH transmission with a same HARQ process number as for the transmission of the first PUSCH and having a toggled NDI field value, the UE
monitors PDCCH in all CORESETs, and receives PDSCH and aperiodic CSI-RS in a resource from a CSI-RS resource set using the same antenna port quasi co-location parameters as the ones associated with the corresponding index q_{new}, if any
transmits PUCCH, PUSCH and SRS that uses a same spatial domain filter with same indicated TCI state as for the PUCCH and PUSCH, using a same spatial domain filter as the one corresponding to q_{new}, if any, and using a power determined with
   qᵤ=0, q_{d}=q_{new}, and l=0 for a PUCCH,
   j=2, q_{d}=q_{new}, l=0 for a PUSCH, and
   qₛ=0, q_{d}=q_{new}, and l=0 for an SRS.

If option 2 is adopted, the following clause dealing with beam failure recovery (BFR) in section 6 entitled “Link recovery procedures” of the Rel. 17 NR Specification or all other subsequent versions may be revised as follows:

If a UE is provided TCI-State_r17 indicating a unified TCI state, after X symbols from a last symbol of a PDCCH reception with a DCI format scheduling a PUSCH transmission with a same HARQ process number as for the transmission of the first PUSCH and having a toggled NDI field value, the UE
monitors PDCCH in all CORESETs, and receives PDSCH and aperiodic CSI-RS in a resource from a CSI-RS resource set using the same antenna port quasi co-location parameters as the ones associated with the corresponding index q_{new}, if any
transmits PUCCH, PUSCH and SRS that uses a same spatial domain filter with same indicated TCI state as for the PUCCH and PUSCH, using a same spatial domain filter as the one corresponding to q_{new}, if any, and using a power determined with
   qᵤ=0, q_{d}=q_{new}, and l=0 for PUCCH,
   j=0 if PUSCH is the one during random access, j=1 if PUSCH is a configured grant based PUSCH, and j=2 if PUSCH is dynamically granted, q_{d}=q_{new}, and l=0 for PUSCH, and
   qₛ=0, q_{d}=q_{new}, and l=0 or 1 for SRS.
      It shall be understood that the above clause may include both options 1 and 2.

Then, according to the beam failure recovery (BFR) procedure, the UE 1002 transmits one or more UL signals 1024 using the new transmit-receiver beam pair qnew and a power control parameter associated with or assigned to a beam failure recovery (BFR) procedure. As previously discussed, the one or more UL signals 1024 may be a PUSCH, a PUCCH, and/or an SRS transmission.

In some aspects, the UE 1002 may further receive a unified TCI indication of UL TCI or joint TCI state, and the UE 1002 may apply the unified TCI for corresponding uplink channels, such as PUCCH, PUSCH, and/or SRS. The UE 1002 may reset the accumulation of a power control adjustment state for the corresponding uplink channel (PUCCH, PUSCH and/or SRS) on the active UL BWP of the carrier in the serving cell to be zero, if a configuration for a corresponding nominal transmit power or a corresponding path-loss compensation factor is provided by higher layers or updated based on the applied UL or joint TCI state. For example:

A UE resets the accumulation of a PUSCH power control adjustment state l for active UL BWP b of carrier f of serving cell c to f_{b,f,c}(k, l)=0, k=0, 1, . . . , i, where i is the transmission occasion index: if a configuration for a corresponding nominal transmit power P_{O_UE_PUSCH,b,f,c}(j) value is provided by higher layers or updated based on the applied UL or joint TCI state; or if a configuration for a corresponding pathloss compensation factor α_{b,f,c}(j) value is provided by higher layers or updated based on the applied UL or joint TCI state.

A UE resets the accumulation of a PUCCH power control adjustment state g_{b,f,c}(k,l)=0, k=0, 1, . . . , i, where i is the transmission occasion index: if a configuration of a nominal transmit power P_{O_PUCCH,b,f,c}(qᵤ) value for a corresponding PUCCH power control adjustment state I for active UL BWP b of carrier f of primary cell c is provided by higher layers, or updated based on the applied UL or joint TCI state.

A UE resets accumulation of a SRS power control adjustment state h_{b,f,c}(k, l)=0, k=0, 1, . . . , i where i is the transmission occasion index: if a configuration of a nominal transmit power P_{O_SRS,b,f,c}(qₛ) value or a pathloss compensation factor α_{SRS,b,f,c}(qₛ) value for a corresponding SRS power control adjustment state I for active UL BWP b of carrier f of serving cell c is provided by higher layers, or updated based on the applied UL or joint TCI state.

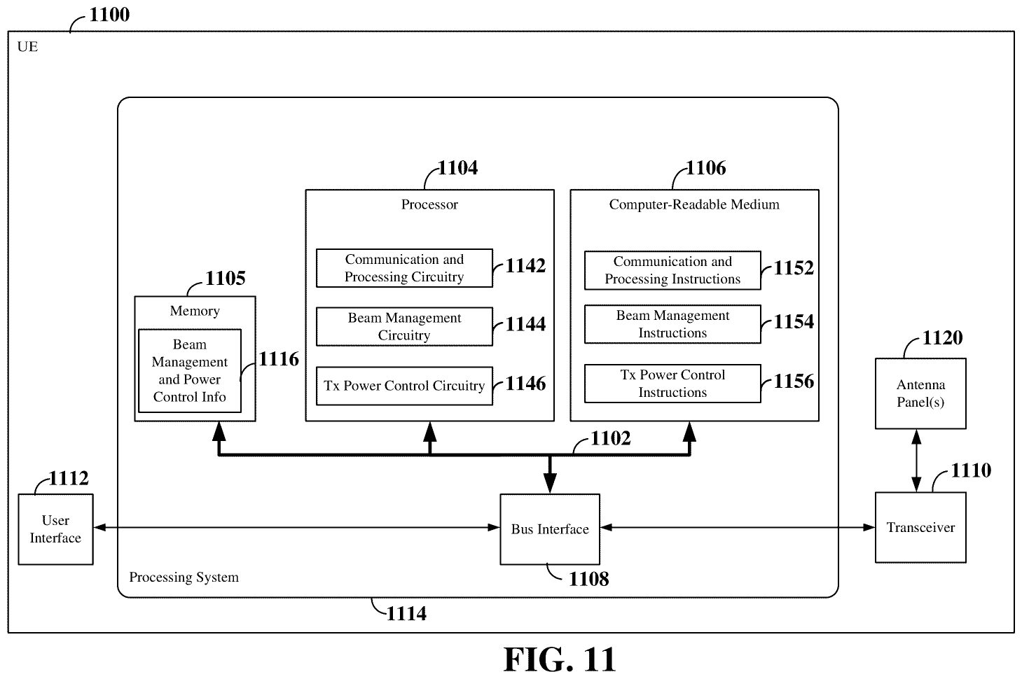

FIG. 11 is a block diagram illustrating an example of a hardware implementation of a user equipment (UE) 1100 employing a processing system 1114 according to some aspects. The UE 1100 may be any of the UEs or other scheduled entities illustrated in any one or more of FIGS. 1, 2, and/or 6-10.

In accordance with various aspects of the disclosure, an element, or any portion of an element, or any combination of elements may be implemented with a processing system 1114 that includes one or more processors, such as processor 1104. Examples of processors 1104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1100 may be configured to perform any one or more of the functions described herein. That is, the processor 1104, as utilized in the UE 1100, may be used to implement any one or more of the methods or processes described and illustrated, for example, in FIG. 10.

The processor 1104 may in some instances be implemented via a baseband or modem chip and in other implementations, the processor 1104 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1114 may be implemented with a bus architecture, represented generally by the bus 1102. The bus 1102 may include any number of interconnecting buses and bridges depending on the specific application of the processing system 1114 and the overall design constraints. The bus 1102 communicatively couples together various circuits, including one or more processors (represented generally by the processor 1104), a memory 1105, and computer-readable media (represented generally by the computer-readable medium 1106). The bus 1102 may also link various other circuits such as timing sources, peripherals, voltage regulators, and power management circuits, which are well known in the art, and therefore, are not described any further.

A bus interface 1108 provides an interface between the bus 1102 and a transceiver 1110. The transceiver 1110 may be, for example, a wireless transceiver. The transceiver 1110 provides a means for communicating with various other apparatus over a transmission medium (e.g., air interface). The transceiver 1110 may further be coupled to one or more antenna panels 1120 configured to generate one or more uplink transmit/downlink receive beams. The bus interface 1108 further provides an interface between the bus 1102 and a user interface 1112 (e.g., keypad, display, touch screen, speaker, microphone, control features, etc.). Of course, such a user interface 1112 may be omitted in some examples.

The computer-readable medium 1106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1106 may reside in the processing system 1114, external to the processing system 1114, or distributed across multiple entities including the processing system 1114. The computer-readable medium 1106 may be embodied in a computer program product. By way of example, a computer program product may include a computer-readable medium in packaging materials. In some examples, the computer-readable medium 1106 may be part of the memory 1105. Those skilled in the art will recognize how best to implement the described functionality presented throughout this disclosure depending on the particular application and the overall design constraints imposed on the overall system. In some examples, the computer-readable medium 1106 may be implemented on an article of manufacture, which may further include one or more other elements or circuits, such as the processor 1104 and/or memory 1105.

The computer-readable medium 1106 may store computer-executable code (e.g., software). Software shall be construed broadly to mean instructions, instruction sets, code, code segments, program code, programs, subprograms, software modules, applications, software applications, software packages, routines, subroutines, objects, executables, threads of execution, procedures/processes, functions, etc., whether referred to as software, firmware, middleware, microcode, hardware description language, or otherwise.

One or more processors, such as processor 1104, may be responsible for managing the bus 1102 and general processing, including the execution of the software (e.g., instructions or computer-executable code) stored on the computer-readable medium 1106. The software, when executed by the processor 1104, causes the processing system 1114 to perform the various processes and functions described herein for any particular apparatus. The computer-readable medium 1106 and/or the memory 1105 may also be used for storing data that may be manipulated by the processor 1104 when executing software. For example, the memory 1105 may store beam management and power control information 1116 associated with the reception and/or transmission of signals.

In some aspects of the disclosure, the processor 1104 may include circuitry configured for various functions. For example, the processor 1104 may include communication and processing circuitry 1142 configured to communicate with a network entity (e.g., a base station, such as a gNB or eNB). In some examples, the communication and processing circuitry 1142 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1142 may include one or more transmit/receive chains.

In some implementations where the communication involves receiving information, the communication and processing circuitry 1142 may obtain information from a component of the UE 1100 (e.g., from the transceiver 1110 that receives the information via radio frequency signaling or some other type of signaling suitable for the applicable communication medium), process (e.g., decode) the information, and output the processed information. For example, the communication and processing circuitry 1142 may output the information to another component of the processor 1104, to the memory 1105, or to the bus interface 1108. In some examples, the communication and processing circuitry 1142 may receive one or more of signals, messages, other information, or any combination thereof. In some examples, the communication and processing circuitry 1142 may receive information via one or more channels. In some examples, the communication and processing circuitry 1142 may include functionality for a means for receiving. In some examples, the communication and processing circuitry 1142 may include functionality for a means for processing, including a means for demodulating, a means for decoding, etc.

In some implementations where the communication involves sending (e.g., transmitting) information, the communication and processing circuitry 1142 may obtain information (e.g., from another component of the processor 1104, the memory 1105, or the bus interface 1108), process (e.g., modulate, encode, etc.) the information, and output the processed information. For example, the communication and processing circuitry 1142 may output the information to the transceiver 1110 (e.g., that transmits the information via radio frequency signaling or some other type of signaling suitable for the applicable communication medium). In some examples, the communication and processing circuitry 1142 may send one or more of signals, messages, other information, or any combination thereof. In some examples, the communication and processing circuitry 1142 may send information via one or more channels. In some examples, the communication and processing circuitry 1142 may include functionality for a means for sending (e.g., a means for transmitting). In some examples, the communication and processing circuitry 1142 may include functionality for a means for generating, including a means for modulating, a means for encoding, etc.

For example, the communication and processing circuitry 1142, under the control of communication and processing instructions 1152 stored in the computer-readable medium 1106, may transmit a beam failure recovery (BFR) request using the selected transmit-receive beam pair indicated by q_{new} to a network entity using the transceiver 1110 and antenna panel 1120. The communication and processing circuitry 1142, under the control of communication and processing instructions 1152 stored in the computer-readable medium 1106, may receive a beam failure recovery (BFR) request response using the selected transmit-receive beam pair indicated by q_{new} from the network entity using the transceiver 1110 and antenna panel 1120.

Additionally, the communication and processing circuitry 1142, under the control of communication and processing instructions 1152 stored in the computer-readable medium 1106, may receive data via a PDSCH and a reference signal (e.g., an aperiodic channel state information reference signal (CSI-RS) in a resource from a CSI-RS resource set) using a same antenna port quasi co-location parameters as ones associated with the selected transmit-receive beam pair indicated by q_{new} from the network entity using the transceiver 1110 and antenna panel 1120. The communication and processing circuitry 1142, under the control of communication and processing instructions 1152 stored in the computer-readable medium 1106, may transmit one or more UL signals (e.g., a PUCCH, PUSCH, SRS, etc.) to the network entity using the selected transmit-receive beam pair indicated by q_{new} and a transmit power according to power control parameter assigned to a beam failure recovery (BFR) procedure.

The processor 1104 may also include beam management circuitry 1144. For example, the beam management circuitry 1144, under the control of beam management instructions 1154 stored in the computer-readable medium 1106, may select a transmit-receive beam pair among a set of candidate transmit-receive beam pairs for communication with a network entity. The beam management circuitry 1144, under the control of beam management instructions 1154 stored in the computer-readable medium 1106, may receive and process a set of reference signals (e.g., SSB, TRS, CSI-RS, etc.) to generate a set of link quality metrics (e.g., RSRPs, SINRs, BLERs, etc.) associated with the set of candidate transmit-receive beam pairs, respectively. The beam management circuitry 1144, under the control of beam management instructions 1154 stored in the computer-readable medium 1106, may detect a failure of the currently-selected transmit-receive beam pair if the associated link quality (e.g., RSRP, SINR, BLER, etc.) drops or rises above a defined threshold. In response to detecting a failure of the currently-selected transmit-receive beam pair, the beam management circuitry 1144, under the control of beam management instructions 1154 stored in the computer-readable medium 1106, may select another one of the set of candidate transmit-receive beam pair based on the best link quality metrics associated with those. The beam management circuitry 1144 may use the information 1116 stored in memory 1105 to perform the aforementioned beam management operations.

The processor 1104 may additionally include a transmit (Tx) power control circuitry 1146. For example, the Tx power control circuitry 1146, under the control of transmit (Tx) power control instructions 1156 stored in the computer-readable medium 1106, may select a nominal transmit power to achieve a target SNR or received signal power at a network entity associated with the transmission of one or more UL signals. The nominal transmit power may depend on the type of UL signals (e.g., PUSCH, PUCCH, SRS, etc.), as well as additional information regarding the UL signals (e.g., a random access, grant configuration, dynamic grant configuration for a PUSCH, or different resource sets of an SRS). The Tx power control circuitry 1146, under the control of transmit (Tx) power control instructions 1156 stored in the computer-readable medium 1106, may estimate pathloss associated with the transmission of UL signals to a network entity, based on a reference signal associated with the selected transmit-receive beam indicated by q_{new}. The Tx power control circuitry 1146, under the control of transmit (Tx) power control instructions 1156 stored in the computer-readable medium 1106, may determine a closed-loop power adjustment associated with the different types of UL signals (e.g., PUSCH, PUCCH, SRS, etc.). The transmit power of the one or more UL signals may be related to a sum of the nominal power, estimated pathloss, and closed-loop power adjustment. The Tx power control circuitry 1146 may use the information 1116 stored in memory 1105 to perform the aforementioned power control operations.

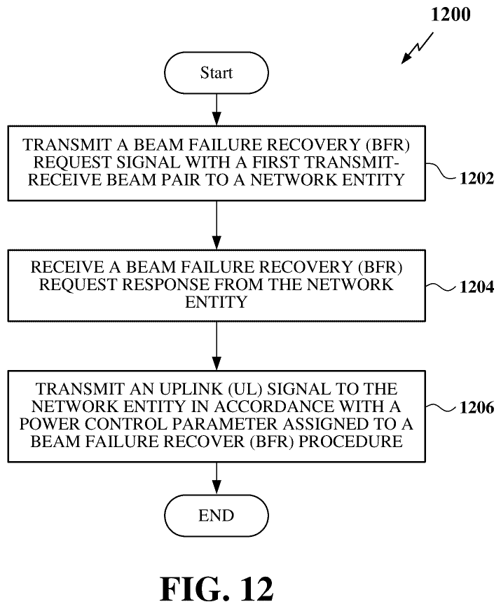

FIG. 12 is a flow chart illustrating an exemplary method 1200 of resetting power control parameters pursuant to a beam failure recovery procedure according to some aspects. As described below, some or all illustrated features may be omitted in a particular implementation within the scope of the present disclosure, and some illustrated features may not be required for implementation of all aspects. In some examples, the method 1200 may be performed by the UE 1100, as described herein and illustrated in FIG. 11, by a processor or processing system, or by any suitable means for carrying out the described functions.

At block 1202, the UE transmit a beam failure recovery (BFR) request signal with a first transmit-receive beam pair to a network entity. For example, the communication and processing circuitry 1142 together with the transceiver 1110 and antenna panel(s) 1120, shown and described above in connection with FIG. 11, may provide a means for transmitting the beam failure recovery (BFR) request signal.

At block 1204, the UE may receive a beam failure recovery (BFR) request response from the network entity. For example, the communication and processing circuitry 1142 together with the transceiver 1110 and antenna panel(s) 1120, shown and described above in connection with FIG. 11, may provide a means for receiving the beam failure recovery (BFR) request response signal.

At block 1206, the UE may transmit an uplink (UL) signal to the network entity in accordance with a power control parameter assigned to a beam failure recovery (BFR) procedure. For example, the communication and processing circuitry 1142 together with the transceiver 1110 and antenna panel(s) 1120, shown and described above in connection with FIG. 11, may provide a means for the UE may transmit an uplink (UL) signal.

In some examples, the power control parameter is selected by the Tx power control circuitry 1146. In some examples, the power control parameter specifies a nominal power for transmission of the UL signal. In some examples, the nominal power is configured to achieve a target signal-to-noise ratio (SNR) or a target received signal power associated with the UL signal at the network entity. In some examples, the UL signal is transmitted via a physical uplink shared channel (PUSCH), and the nominal power parameter has an index j=2 as specified in Rel. 17 NR Specification. In some examples, the UL signal is transmitted via a physical uplink control channel (PUCCH), and the nominal power parameter has an index qᵤ=0 as specified in Rel. 17 NR Specification. In some examples, the UL signal is a sounding reference signal (SRS), and the nominal power parameter has an index qₛ=0 as specified in Rel. 17 NR Specification.

In some examples, wherein the UL signal is a random access transmitted via a physical uplink shared channel (PUSCH), and wherein the nominal power parameter has an index j=0 as specified in Rel. 17 NR Specification. In some examples, the UL signal pertains to configuring an access grant transmitted via a physical uplink shared channel (PUSCH), and wherein the nominal power parameter has an index j=1 as specified in Rel. 17 NR Specification. In some examples, the UL signal pertains to configuring a dynamic grant transmitted via a physical uplink shared channel (PUSCH), and wherein the nominal power parameter has an index j=2 as specified in Rel. 17 NR Specification.

In some examples, the communication and processing circuitry 1142 receives a reference signal associated with the first transmit-receive beam pair from the network entity using the transceiver. In some examples, the power control parameter specifies an estimated signal pathloss between the UE and the network entity related to the reference signal. In some examples, the Tx power control circuitry 1146 may determine the estimated signal pathloss between the UE and the network entity based on the reference signal. In some examples, the reference signal is associated with the first transmit-receive beam pair.

In some examples, the communication and processing circuitry 1142 may monitor a physical downlink control channel (PDCCH) in one or more CORESETs to receive the reference signal after a defined time interval from when the processor received the receive the beam failure recovery (BFR) request response from the network entity. In some examples, the defined time interval has a length indicated in orthogonal frequency division multiplexed (OFDM) symbols. In some examples, the length of the defined time interval is 28 OFDM symbols.

In some examples, the beam management circuitry 1144 may detect a failure with a second transmit-receive beam pair used to communicate with the network entity, and the communication and processing circuitry 1142 may transmit the beam failure recovery (BFR) request signal in response to the detection of the failure of the second transmit-receive beam pair. In some examples, the beam management circuitry 1144 may detect the failure of the second transmit-receive beam pair based on at least one measured link quality parameter associated with a signal received from the network entity via the second transmit-receive beam pair using the transceiver. In some examples, the beam management circuitry 1144 may select the first transmit-receive beam pair from a set of candidate transmit-receive beam pairs based on a set of link quality parameters associated with the set of candidate transmit-receive beam pairs, respectively. The beam management circuitry 1144 may use the information 1116 stored in the memory 1105 in performing the aforementioned beam management operations.

In one configuration, the UE 1100 includes means for transmitting a beam failure recovery (BFR) request signal with a first transmit-receive beam pair to a network entity, means for receive a beam failure recovery (BFR) request response from the network entity, and means for transmitting an uplink (UL) signal to the network entity in accordance with the first transmit-receive beam pair and a power control parameter assigned to a beam failure recovery (BFR) procedure. The UE 1100 may further include means for specifying a nominal power, estimating signal pathloss, and determining closed-loop power adjustment based on the type of UL signals to be transmitted. The UE 1100 includes means for determining a set of link quality parameters for a set of candidate transmit-receive beam pairs, respectively. The UE 1100 includes means for detecting a failure of the current transmit-receive beam pairs. The UE 1100 includes means for selecting a new transmit-receive beam pair among the set of candidate transmit-receive beam pairs based on the set of link quality parameters, respectively.

Of course, in the above examples, the circuitry included in the processor 1104 is merely provided as an example, and other means for carrying out the described functions may be included within various aspects of the present disclosure, including but not limited to the instructions stored in the computer-readable storage medium 1106, or any other suitable apparatus or means described in any one of the FIGS. 1, 2, and/or 6-10, and utilizing, for example, the processes and/or algorithms described herein in relation to FIGS. 10 and 12.

The following provides an overview of aspects of the present disclosure:

Aspect 1: A user equipment (UE) configured for wireless communication, comprising: a transceiver; a memory; and a processor coupled to the transceiver and the memory, the processor being configured to: transmit a beam failure recovery (BFR) request signal with a first transmit-receive beam pair to a network entity using the transceiver; receive a beam failure recovery (BFR) request response from the network entity using the transceiver; and transmit an uplink (UL) signal to the network entity using the transceiver, wherein the transmission of the UL signal is in accordance with the first transmit-receive beam pair and a power control parameter assigned to a beam failure recovery (BFR) procedure.

Aspect 2: The UE of aspect 1, wherein the power control parameter specifies a nominal power for transmission of the UL signal.

Aspect 3: The UE of aspect 2, wherein the nominal power is configured to achieve a target signal-to-noise ratio (SNR) or target received signal power associated with the UL signal at the network entity.

Aspect 4: The UE of aspect 2 or 3, wherein the UL signal is transmitted via a physical uplink shared channel (PUSCH), and wherein the nominal power parameter has a selected index among a set of different nominal power indices.

Aspect 5: The UE of any one of aspects 2-4, wherein the UL signal is transmitted via a physical uplink control channel (PUCCH), and wherein the nominal power parameter has a selected index among a set of different nominal power indices.

Aspect 6: The UE of any one of aspects 2-5, wherein the UL signal is a sounding reference signal (SRS), and wherein the nominal power parameter is based on a selected resource set of the SRS.

Aspect 7: The UE of any one of aspects 2-6, wherein the UL signal is a random access transmitted via a physical uplink shared channel (PUSCH), and wherein the nominal power parameter has a selected index among a set of different nominal power indices.

Aspect 8: The UE of any one of aspects 2-7, wherein the UL signal pertains to configuring an access grant transmitted via a physical uplink shared channel (PUSCH), and wherein the nominal power parameter has a selected index among a set of different nominal power indices.

Aspect 9: The UE of any one of aspects 2-8, wherein the UL signal pertains to configuring a dynamic grant transmitted via a physical uplink shared channel (PUSCH), and wherein the nominal power parameter has a selected index among a set of different nominal power indices.

Aspect 10: The UE of any one of aspects 2-9, wherein the UL signal is a first resource set of a sounding reference signal (SRS), and wherein the nominal power parameter is based on the first resource set of the SRS.

Aspect 11: The UE of aspect 10, wherein the UL signal is a second resource set of the SRS, wherein the second resource set of the SRS is different than the first resource set of the SRS, and wherein the nominal power parameter is based on the second resource set of the SRS.

Aspect 12: The UE of any one of aspects 1-11, wherein the processor is further configured to receive a reference signal from the network entity using the transceiver.

Aspect 13: The UE of aspect 12, wherein the power control parameter specifies an estimated signal pathloss between the UE and the network entity related to the reference signal.

Aspect 14: The UE of aspect 12 or 13, wherein the reference signal is associated with the first transmit-receive beam pair.

Aspect 15: The UE of any one of aspects 12-14, wherein the processor is further configured to monitor a physical downlink control channel (PDCCH) in one or more CORESETs to receive the reference signal after a defined time interval from when the processor received the receive the beam failure recovery (BFR) request response from the network entity.

Aspect 16: The UE of aspect 15, wherein the defined time interval has a length indicated in orthogonal frequency division multiplexed (OFDM) symbols.

Aspect 17: The UE of aspect 16, wherein the length of the defined time interval is 28 OFDM symbols.

Aspect 18: The UE of any one of aspects 1-17, wherein the processor is further configured to detect a failure with a second transmit-receive beam pair used to communicate with the network entity, wherein the transmission of the beam failure recovery (BFR) request signal is in response to the detection of the failure of the second transmit-receive beam pair.

Aspect 19: The UE of aspect 18, wherein the processor is configured to detect the failure of the second transmit-receive beam pair based on at least one measured link quality parameter associated with a signal received from the network entity via the second transmit-receive beam pair using the transceiver.

Aspect 20: The UE of aspect 18 or 19, wherein the processor is configured to select the first transmit-receive beam pair from a set of candidate transmit-receive beam pairs based on a set of link quality parameters associated with the set of candidate transmit-receive beam pairs, respectively.

Aspect 21: A method for wireless communication at a user equipment (UE), the method comprising: transmitting a beam failure recovery (BFR) request signal with a first transmit-receive beam pair to a network entity; receiving a beam failure recovery (BFR) request response from the network entity; and transmitting an uplink (UL) signal to the network entity, wherein the transmission of the UL signal is in accordance with the first transmit-receive beam pair and a power control parameter assigned to a beam failure recovery (BFR) procedure.

Aspect 22: The method of aspect 21, wherein the power control parameter specifies a nominal power for transmission of the UL signal.

Aspect 23: The method of aspect 22, wherein the nominal power is configured to achieve a target signal-to-noise ratio (SNR) or target received signal power associated with the UL signal at the network entity.

Aspect 24: The method of aspect 22 or 23, wherein the UL signal is transmitted via a physical uplink shared channel (PUSCH), and wherein the nominal power parameter has a selected index among a set of different nominal power indices.

Aspect 25: The method of any one of aspects 22-24, wherein the UL signal is transmitted via a physical uplink control channel (PUCCH), and wherein the nominal power parameter has a selected index among a set of different nominal power indices.

Aspect 26: The method of any one of aspects 22-25, wherein the UL signal is a sounding reference signal (SRS), and wherein the nominal power parameter is based on a selected resource set of the SRS.

Aspect 27: The method of any one of aspects 22-26, wherein the UL signal is a random access transmitted via a physical uplink shared channel (PUSCH), and wherein the nominal power parameter has a selected index among a set of different nominal power indices.

Aspect 28: The method of any one of aspects 22-27, wherein the UL signal pertains to configuring an access grant transmitted via a physical uplink shared channel (PUSCH), and wherein the nominal power parameter has a selected index among a set of different nominal power indices.

Aspect 29: The method of any one of aspects 22-28, wherein the UL signal pertains to configuring a dynamic grant transmitted via a physical uplink shared channel (PUSCH), and wherein the nominal power parameter has a selected index among a set of different nominal power indices.

Aspect 30: The method of any one of aspects 22-29, wherein the UL signal is a first resource set of a sounding reference signal (SRS), and wherein the nominal power parameter is based on a selected resource set of the SRS.

Aspect 31: The method of aspect 30, wherein the UL signal is a second resource set of the SRS, wherein the second resource set of the SRS is different than the first resource set of the SRS, and wherein the nominal power parameter is based on the second resource set of the SRS.

Aspect 32: The method of any one of aspects 21-31, further comprising receiving a reference signal from the network entity.

Aspect 33: The method of aspect 32, wherein the power control parameter specifies an estimated signal pathloss between the UE and the network entity related to the reference signal.

Aspect 34: The method of aspect 32 or 33, wherein the reference signal is associated with the first transmit-receive beam pair.

Aspect 35: The method of any one of aspects 32-34, further comprising monitoring a physical downlink control channel (PDCCH) in one or more CORESETs to receive the reference signal after a defined time interval from receiving the beam failure recovery (BFR) request response from the network entity.

Aspect 36: The method of aspect 35, wherein the defined time interval has a length indicated in orthogonal frequency division multiplexed (OFDM) symbols.

Aspect 37: The method of aspect 36, wherein the length of the defined time interval is 28 OFDM symbols.

Aspect 38: The method of any one of aspects 21-37, further comprising detecting a failure with a second transmit-receive beam pair used to communicate with the network entity, wherein transmitting the beam failure recovery (BFR) request signal is in response to detecting the failure of the second transmit-receive beam pair.

Aspect 39: The method of aspect 38, wherein detecting the failure of the second transmit-receive beam pair is based on at least one measured link quality parameter associated with receive a signal from the network entity using the second transmit-receive beam pair.

Aspect 40: The method of aspect 38 or 39, further comprising selecting the first transmit-receive beam pair from a set of candidate transmit-receive beam pairs based on a set of link quality parameters associated with the set of candidate transmit-receive beam pairs, respectively.

Aspect 41: A non-transitory computer-readable medium having stored therein instructions executable by one or more processors of a base station to perform a method of any one of aspects 21-40.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-19 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1, 2, and/or 6-11 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. The construct A and/or B is intended to cover A, B, and A and B. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

1. A user equipment (UE) configured for wireless communication, comprising:
a transceiver;
a memory; and
a processor coupled to the transceiver and the memory, the processor being configured to:
transmit a beam failure recovery (BFR) request signal with a first transmit-receive beam pair to a network entity using the transceiver;
receive a beam failure recovery (BFR) request response from the network entity using the transceiver; and
transmit an uplink (UL) signal to the network entity using the transceiver, wherein the transmission of the UL signal is in accordance with the first transmit-receive beam pair and a power control parameter assigned to a beam failure recovery (BFR) procedure.

2. The UE of claim 1, wherein the power control parameter specifies a nominal power parameter for the transmission of the UL signal.

3. The UE of claim 2, wherein the nominal power parameter is configured to achieve a target signal-to-noise ratio (SNR) or target received signal power associated with the UL signal at the network entity.

4. The UE of claim 2, wherein the UL signal is transmitted via a physical uplink shared channel (PUSCH), and wherein the nominal power parameter has a selected index among a set of different nominal power indices.

5. The UE of claim 2, wherein the UL signal is transmitted via a physical uplink control channel (PUCCH), and wherein the nominal power parameter has a selected index among a set of different nominal power indices.

6. The UE of claim 2, wherein the UL signal is a sounding reference signal (SRS), and wherein the nominal power parameter is based on a selected resource set of the SRS.

7. The UE of claim 2, wherein the UL signal is a random access transmitted via a physical uplink shared channel (PUSCH), and wherein the nominal power parameter has a selected index among a set of different nominal power indices.

8. The UE of claim 2, wherein the UL signal pertains to configuring an access grant transmitted via a physical uplink shared channel (PUSCH), and wherein the nominal power parameter has a selected index among a set of different nominal power indices.

9. The UE of claim 2, wherein the UL signal pertains to configuring a dynamic grant transmitted via a physical uplink shared channel (PUSCH), and wherein the nominal power parameter has a selected index among a set of different nominal power indices.

10. The UE of claim 2, wherein the UL signal is a first resource set of a sounding reference signal (SRS), and wherein the nominal power parameter is based on the first resource set of the SRS.

11. The UE of claim 10, wherein the UL signal is a second resource set of the SRS, wherein the second resource set of the SRS is different than the first resource set of the SRS, and wherein the nominal power parameter is based on the second resource set of the SRS.

12. The UE of claim 1, wherein the processor is further configured to receive a reference signal from the network entity using the transceiver.

13. The UE of claim 12, wherein the power control parameter specifies an estimated signal pathloss between the UE and the network entity related to the reference signal.

14. The UE of claim 12, wherein the reference signal is associated with the first transmit-receive beam pair.

15. The UE of claim 12, wherein the processor is further configured to monitor a physical downlink control channel (PDCCH) in one or more CORESETs to receive the reference signal after a defined time interval from when the processor received the receive the beam failure recovery (BFR) request response from the network entity.

16-20. (canceled)

21. A method for wireless communication at a user equipment (UE), the method comprising:
transmitting a beam failure recovery (BFR) request signal with a first transmit-receive beam pair to a network entity;
receiving a beam failure recovery (BFR) request response from the network entity; and
transmitting an uplink (UL) signal to the network entity, wherein the transmission of the UL signal is in accordance with the first transmit-receive beam pair and a power control parameter assigned to a beam failure recovery (BFR) procedure.

22. The method of claim 21, wherein the power control parameter specifies a nominal power parameter for the transmission of the UL signal.

23. The method of claim 22, wherein the nominal power parameter is configured to achieve a target signal-to-noise ratio (SNR) or target received signal power associated with the UL signal at the network entity.

24. The method of claim 22, wherein the UL signal is transmitted via a physical uplink shared channel (PUSCH), and wherein the nominal power parameter has a selected index among a set of different nominal power indices.

25. The method of claim 22, wherein the UL signal is transmitted via a physical uplink control channel (PUCCH), and wherein the nominal power parameter has a selected index among a set of different nominal power indices.

26. The method of claim 22, wherein the UL signal is a sounding reference signal (SRS), and wherein the nominal power parameter is based on a selected resource set of the SRS.

27. The method of claim 22, wherein the UL signal is a random access transmitted via a physical uplink shared channel (PUSCH), and wherein the nominal power parameter has a selected index among a set of different nominal power indices.

28. The method of claim 22, wherein the UL signal pertains to configuring an access grant transmitted via a physical uplink shared channel (PUSCH), and wherein the nominal power parameter has a selected index among a set of different nominal power indices.

29. The method of claim 22, wherein the UL signal pertains to configuring a dynamic grant transmitted via a physical uplink shared channel (PUSCH), and wherein the nominal power parameter has a selected index among a set of different nominal power indices.

30. The method of claim 22, wherein the UL signal is a first resource set of a sounding reference signal (SRS), and wherein the nominal power parameter is based on the first resource set of the SRS.

31. The method of claim 30, wherein the UL signal is a second resource set of the SRS, wherein the second resource set of the SRS is different than the first resource set of the SRS, and wherein the nominal power parameter is based on the second resource set of the SRS.

32. The method of claim 21, further comprising receiving a reference signal from the network entity.

33. The method of claim 32, wherein the power control parameter specifies an estimated signal pathloss between the UE and the network entity related to the reference signal.

34. The method of claim 32, wherein the reference signal is associated with the first transmit-receive beam pair.

35. The method of claim 32, further comprising monitoring a physical downlink control channel (PDCCH) in one or more CORESETs to receive the reference signal after a defined time interval from receiving the beam failure recovery (BFR) request response from the network entity.

36-40. (canceled)
